(19) United States
(12) Patent Application Publication
(10) Pub. No.: US 2005/0040156 A1
(43) Pub. Date: Feb. 24, 2005

(54) Radiant electric heater

(76) Inventor: Stuart Lamb, Redditch (GB)

Correspondence Address: IRA S. DORMAN, SUITE 200, 330 ROBERTS STREET, EAST HARTFORD, CT, 06108, US

(21) Appl. No.: 10/887,178

(22) Filed: Jul. 7, 2004

(30) Foreign Application Priority Data
Jul. 16, 2003 (GB) 0316627.9

(51) Int. Cl. H05B 3/68

(52) U.S. Cl. 219/460.1

(57) ABSTRACT

A radiant electric heater comprises at least first and second adjacent heating zones (8, 12), the first heating zone (8) including a first heating element (6) and the second heating zone (12) including a second heating element (10). The heating elements are supported relative to a base (4) of thermal and electrical insulation material. Terminal means (30) is provided at a periphery of the heater for connecting the first and second heating elements (6, 10) to a source of electrical energy. The heating elements (6, 10) are formed from a single elongate electrically conductive material, the heating elements having a conjoined first terminal region (20) connected to a first electrical connector (32) at the terminal means (30), having a free second terminal region (18) connected to a second electrical connector (34) at the terminal means (30), and having a free third terminal region (16) connected to a third electrical connector (36) at the terminal means (30). At least one of the first, second and third terminal regions (20, 16, 18) traverses the second heating zone (12) for connection to the respective electrical connector (32, 34, 36).

This invention relates to a radiant electric heater and in particular relates to a radiant electric heater, for example for a glass-ceramic cooking appliance, comprising at least first and second adjacent heating zones.

### DESCRIPTION OF PRIOR ART

It is known to manufacture radiant electric heaters for glass-ceramic top cooking appliances which are provided with two heating zones in the form of an inner, circular, heating zone and an outer, annular, heating zone extending around the inner zone. The inner and outer heating zones may, or may not, be separated by a dividing wall of thermal insulating material so as to define, if desired, separate and distinct heating zones on the glass-ceramic cooking surface. The inner and outer heating zones are each constituted by a heating element in the form of a ribbon or coil material which is configured to occupy the space allotted to the heating zone concerned and which is supported on a base of thermal insulation material provided in a dish-like support. Thus, a first heating element is provided in the inner heating zone and a second heating element is provided in the outer heating zone. A probe-type temperature sensor, or other suitable type of temperature sensor, extends over the outer and inner heating zones and is adapted to be responsive in particular to the temperature of the glass-ceramic cooking surface in the region of the inner heating zone. The heating elements are connected to the temperature sensor and to a source of electrical power by way of a terminal block provided at a peripheral wall of the supporting dish. The terminal block is provided adjacent to the temperature sensor and is formed with three electrical connectors, a first connector adjacent to the temperature sensor, a second connector remote from the temperature sensor and a third connector intermediate the first and second connectors. It is common practice in such heaters to connect the first connector externally of the supporting dish directly to an electrical connector of the temperature sensor, for example by means of welding, and internally of the dish to one end of each of the first and second heating elements. It is also common practice to connect the other end of the second heating element to the second connector within the dish and to connect the other end of the first heating element to the third connector within the dish, the connection between the end of the first heating element and the third connector being by way of a link which is secured at one end of the first heating element, passes over the end of the second heating element, and is connected to, or integral with, the third connector.

Disadvantages of such known radiant electric heaters are that the presence of two separate heating elements and the manner in which the heating elements are secured to the electrical connectors, particularly involving one or more separate links, render the insertion of the heating elements into their positions on the base of insulating material in the supporting dish unsuitable for automatic production methods.

### OBJECT OF THE INVENTION

It is an object of the present invention to overcome or minimise the above problems.

### SUMMARY OF THE INVENTION

According to the present invention there is provided a radiant electric heater comprising at least first and second adjacent heating zones, the first heating zone including a first heating element and the second heating zone including a second heating element, the heating elements being supported relative to a base of thermal and electrical insulation material, and terminal means provided at a periphery of the heater for connecting the first and second heating elements to a source of electrical energy, wherein the heating elements are formed from a single elongate electrically conductive member, the heating elements having a conjoined first terminal region connected to a first electrical connector at the terminal means, having a free second terminal region connected to a second electrical connector at the terminal means, and having a free third terminal region connected to a third electrical connector at the terminal means, wherein at least one of the first, second and third terminal regions traverses the second heating zone for connection to the respective electrical connector.

The heating elements may be in the form of a ribbon secured upright into the base of thermal and electrical insulation material.

The first heating zone may be circular, with the second heating zone being at least part-circular and at least partially surrounding the first heating zone. The conjoined terminal regions of the heating elements may comprise a looped distal region of the second heating element welded to a portion of the first heating element.

A peripheral wall may be provided around the external periphery of the heater.

A dividing wall may be provided between the adjacent heating zones.

A temperature-responsive device may be provided for sensing the temperature in the region of at least the first heating zone.

The at least one of the first, second and third terminal regions traversing the second heating zone may comprise a plurality of portions of the elongate electrically conductive member electrically connected in parallel.

The plurality of portions of the elongate electrically conductive member electrically connected in parallel may comprise a plurality of elongate close meanders of the elongate electrically conductive member traversing the second heating zone and electrically interconnected thereacross at least at opposite ends thereof, such as by welding, folding or crimping.

The meanders may comprise elongate substantially straight sections interconnected by one or more looped ends and may have one or more looped ends thereof which has or have been severed subsequent to electrical interconnection of the meanders in parallel.

One or more of cuts and welds may be provided at one or more portions of the electrically conductive member, in particular to respectively disconnect and reconnect one or more portions of the elongate electrically conductive member, particularly at the terminal regions thereof.

The at least one of the terminal regions of the elongate electrically conductive member may traverse the second heating zone such as to overlie or underlie the second heating element and spaced therefrom.

The at least one of the terminal regions of the elongate electrically conductive member may be provided in one or more recesses or grooves formed in the base of thermal and electrical insulation material underlying the second heating element.

The free first terminal region may be provided in the second heating zone at an end of the second heating element remote from the conjoined terminal region, with the free second terminal region being provided at an end of the first heating element remote from the conjoined terminal region, the conjoined terminal region and the free first terminal region traversing the second heating zone.

The at least one of the terminal regions traversing the second heating zone may be substantially non-visibly radiating, or of reduced visible radiance relative to the remainder of the heating elements, when the heater is energised.

The third electrical connector may be positioned intermediate the first and second electrical connectors.

The terminal regions of the heating elements may be connected to the respective first, second and third electrical connectors by welding.

The terminal means may comprise at least one terminal block supported at the periphery of the heater and accommodating the first, second and third electrical connectors.

The elongate electrically conductive member forming the first and second heating elements with their conjoined and free terminal regions may be provided as a pre-formed component for supporting relative to the base of thermal and electrical insulation material.

A dish-like support, such as of metal, may be provided, receiving the base of thermal and electrical insulation material. The terminal means may be supported at a peripheral rim of the dish-like support.

By means of the present invention, a cost-effective radiant electric heater is provided having at least two heating zones and in which at least two heating elements and their associated terminal regions are integrally provided for assembly onto a base of thermal and electrical insulation material, to form the heater. An assembly of the heating elements and their associated terminal regions is readily provided by automated techniques, suitably comprising the use of a jig means into which the integral heating elements are wound, and their terminal regions formed. The assembly is then readily transferred from the jig to the base of insulation material and into the surface of which it is suitably impressed and secured.

For a better understanding of the present invention and to show more clearly how it may be carried into effect, reference will now be made by way of example to the accompanying drawings in which:

### BRIEF DESCRIPTION OF THE DRAWINGS

FIG. 1 is a plan view of an embodiment of a radiant electric heater according to the present invention;

FIG. 2 is a perspective view of a portion of ribbon form heating element material as used in the heater of FIG. 1;

FIG. 3 is a perspective view of part of a jig in which is formed the integral heating elements and terminal regions thereof of the heater of FIG. 1; and

FIG. 4 is a plan view of another embodiment of a radiant electric heater according to the present invention.

### DESCRIPTION OF PREFERRED EMBODIMENTS

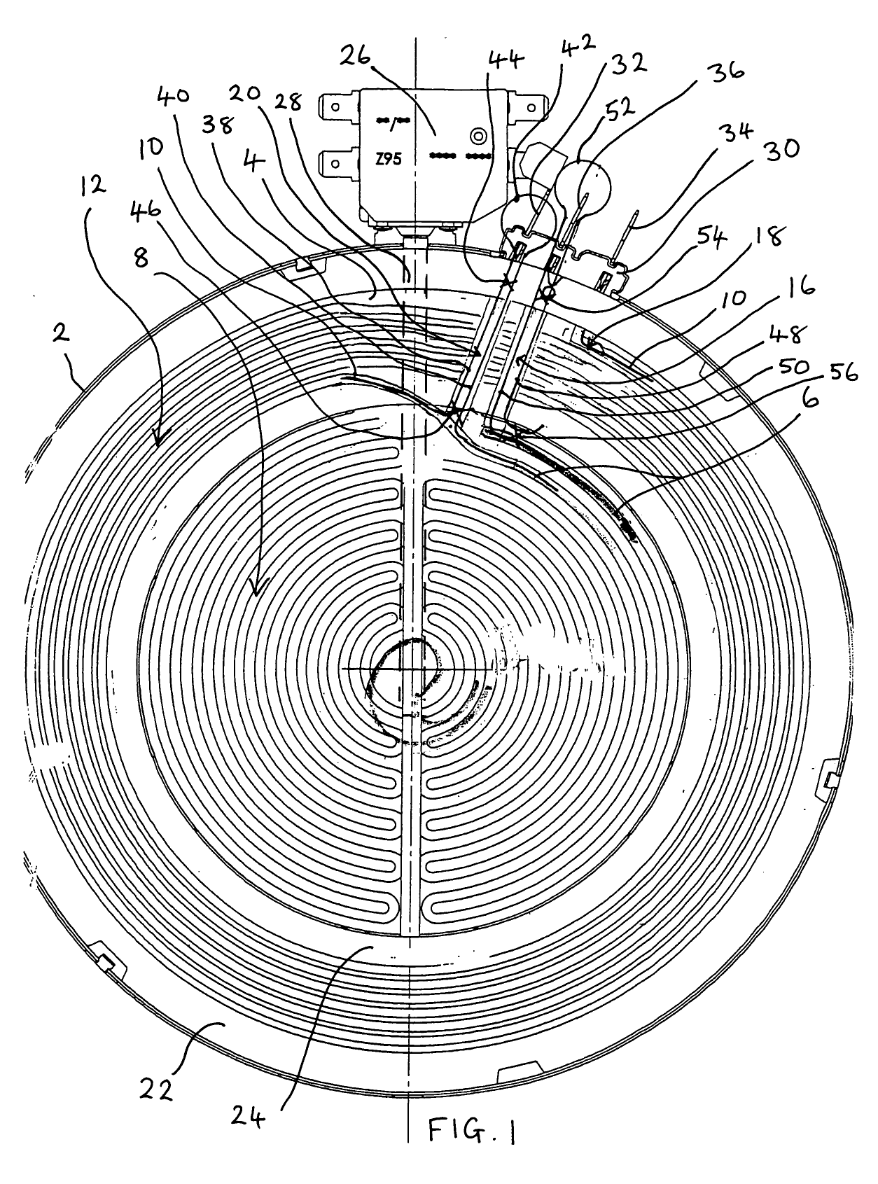

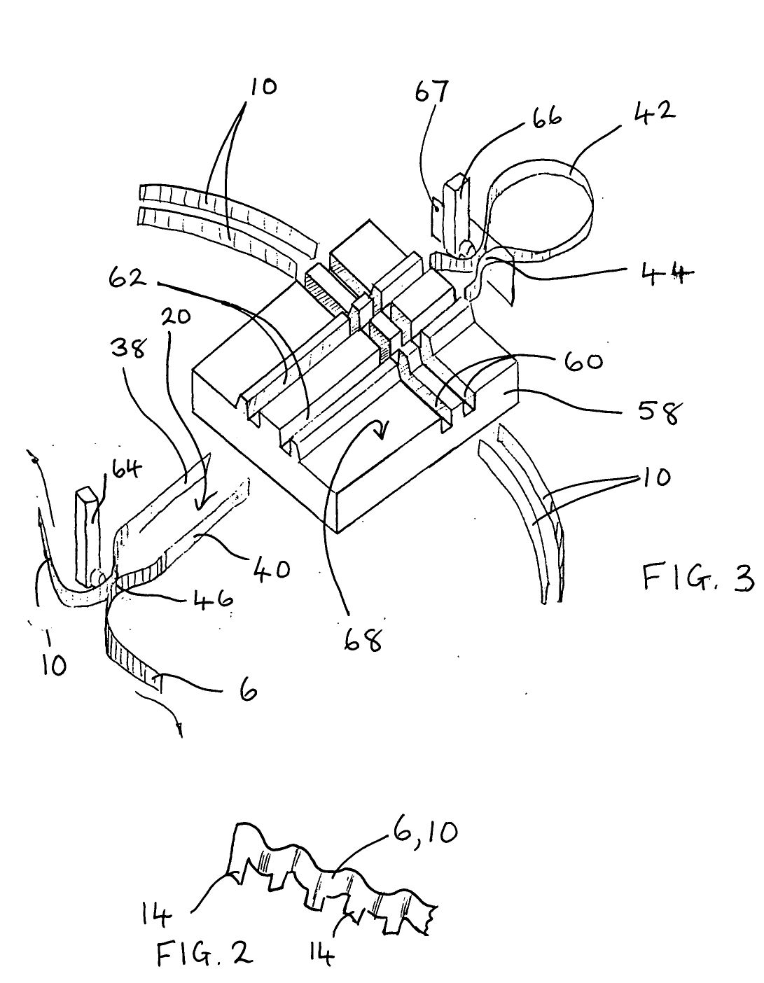

Referring to FIG. 1, a radiant electric heater comprises a dish-like support 2, for example of metal, containing a base 4 of thermal and electrical insulation material, for example compressed microporous thermal and electrical insulation material. Secured to the base 4 is a first heating element 6 of ribbon form material inserted upright into the base, the first heating element 6 occupying a substantially circular inner first heating zone 8 in the central region of the heater. Also secured to the base 4 is a second heating element 10 of ribbon form material inserted upright into the base, the second heating element 10 occupying a substantially annular outer second heating zone 12 around the peripheral region of the heater. The first and second heating elements 6, 10 are integral, formed of a single elongate electrically conductive member in the form of a length of the ribbon form heating element material. The integral ribbon form heating elements 6, 10 may be of corrugated from, such as shown in FIG. 2 and may be provided with legs 14, integral therewith or secured thereto, for insertion into the base 4 of insulation material.

As will be described in detail hereinafter, the first heating element 6 has a free terminal region 16 and the second heating element 10 has a free terminal region 18. The first and second heating elements 6, 10 also have a conjoined terminal region 20.

In practice, the first heating element 6 is arranged to be energised whenever the heater is energised, irrespective of the size of a cooking utensil placed on a cooking surface (not shown) below which the heater is arranged, while the second heating element 10 is only energised in conjunction with the first heating element 6, and only when a relatively large cooking utensil is used such that the cooking utensil overlies both the first and second heating elements 6, 10.

A peripheral wall 22 of thermal insulation material extends around the periphery of the heater between the outer second heating zone 12 and an upstanding rim of the dish-like support 2.

A dividing wall 24 of thermal insulation material may optionally be provided between the first 8 and second 12 heating zones.

A probe-type temperature-responsive device 26 extends from a periphery of the heater, a temperature-sensing portion 28 of the device 26 extending substantially over the first heating element 6 in the inner first heating zone 8.

A terminal block 30 is mounted on the upstanding peripheral rim of the dish-like support 2 adjacent to the temperature-responsive device 26 and is provided with a first electrical connector 32 adjacent to the temperature-responsive device 26, a second electrical connector 34 remote from the temperature-responsive device and with a third electrical connector 36 intermediate the first and second electrical connectors.

Externally of the dish-like support 2, the first electrical connector 32 may be connected directly, for example by welding, to an electrical connector of the temperature-responsive device 26.

The conjoined terminal region 20 of the first and second heating elements 6, 10 comprises meanders of the ribbon form heating element material traversing the second heating zone 12 and consisting of two elongate substantially straight sections 38, 40 interconnected by a loop 42. Such two elongate substantially straight sections 38, 40 may traverse the second heating zone 12 such that they overlie or underlie and are spaced from the second heating element 10. They are preferably arranged to underlie the second heating element 10 and are provided in one or more recesses or grooves pressed into the base 4 of insulation material underneath the second heating element 10. The two elongate substantially straight sections 38, 40 are electrically connected in parallel by welding them together at regions 44 and 46 at opposite ends thereof. They are also welded to the first electrical connector 32 inside the heater. The loop 42 is effectively redundant and is removed by severing, suitably prior to locating the integral heating elements 6, 10 on the base 4.

The free terminal region 16 of the first heating element 6 likewise comprises meanders of the ribbon form heating element material traversing the second heating zone 12 and consisting of two elongate substantially straight sections 48, 50, interconnected by a loop 52. Section 48 is open-ended. The sections 48, 50 traverse the second heating zone 12, preferably underlying and spaced from the second heating element 10 in the same way as described for the sections 38, 40 of the conjoined terminal region 20. The two elongate substantially straight sections 48, 50 are electrically connected in parallel by welding them together at regions 54, 56 at opposite ends thereof. They are also welded to the third electrical connector 36 inside the heater. The loop 52 is effectively redundant and is removed by severing in the same way as the loop 42.

The free terminal region 18 of the second heating element 10 in the outer second heating zone 12 is electrically connected by welding to the second electrical connector 34.

The heater is operated either by electrically connecting a power supply (not shown) to the electrical connectors 32 and 36 to energise only the first heating element 6, or by electrically connecting the power supply to the electrical connectors 34 and 36 to energise both the first heating element 6 and the second heating element 10 in parallel.

Because the terminal regions 16 and 20 comprise two sections of ribbon form material connected in parallel, they emit substantially no visible radiation, or less visible radiation than the remainder of the heating elements 6, 10 when energised, thereby eliminating any requirement for providing shielding or screening of these terminal regions.

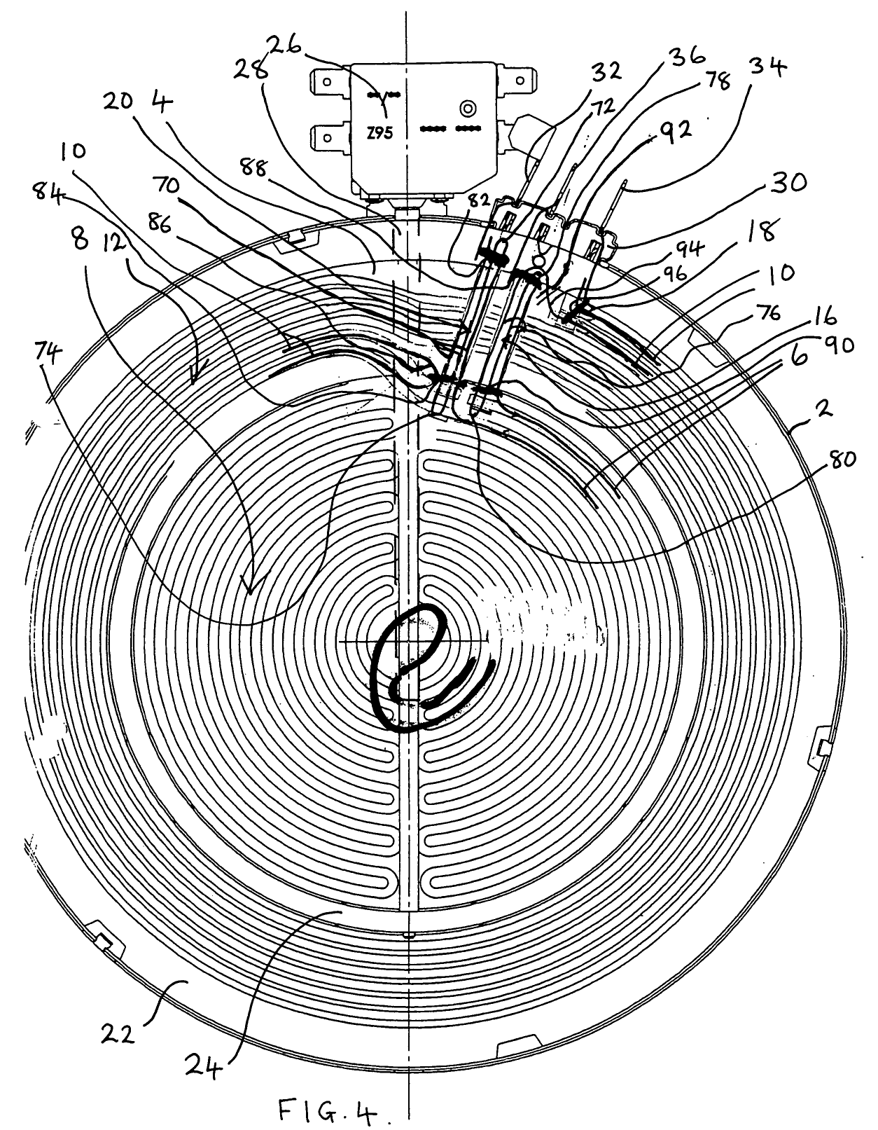

The integral first and second heating elements 6, 10 with their terminal regions 16, 18 and 20 are advantageously produced as a pre-formed component for securing into the base 4 of insulation material. Such a pre-formed component is suitably prepared by winding the integral first and second heating elements 6, 10, with their terminal regions 16, 18, 20, into a jig and then transferring the resulting pre-formed component from the jig to the base 4 of insulation material by appropriate pressing. Part of such a jig is shown in FIG. 3. The jig 58 has grooves 60 into which the second heating element 10 is first wound. This is followed by winding in of the first heating element 6 and the conjoined terminal regions 20 and the free terminal region 16.

Only the conjoined terminal regions 20 are shown in FIG. 3, the free terminal region 16 being similarly arranged. As shown in FIG. 3, the two elongate substantially straight sections 38, 40 of the conjoined terminal regions 20 are located in grooves 62 in the jig 58, overlying the outer heating element 10. The welds 44 and 46 are formed by means of welding heads 64, 66 and the loop 42 is then removed by suitable cutting means 67.

The jig 58 is then located with the face 68 thereof in contact with the base 4 of insulation material in the dish-like support 2 of the heater and pressure is applied to transfer the pre-formed assembly of the heating elements 6, 10, together with their terminal regions 16, 18, 20, to the base 4 and to secure the assembly to the base 4, with the terminal regions 16, 20 deeply recessed into the base 4 and with the outer heating element 10 overlying and spaced from the terminal regions 16, 20.

Another embodiment of a radiant electric heater according to the present invention, with an alternative arrangement of the terminal regions, is illustrated in FIG. 4. Here, as in FIG. 1, a dish-like support 2 is provided, with a base 4 of thermal and electrical insulation material, a peripheral wall 22, and an optional dividing wall 24. First and second heating elements 6 and 10 are integrally provided in an inner first heating zone 8 and an outer second heating zone 12 respectively. Conjoined terminal regions 20 are provided for the heating elements 6, 10 and free terminal regions 16 and 18 are provided for the first 6 and second 10 heating elements respectively.

The terminal regions 16 and 20 comprise meanders of the ribbon form heating element material traversing the second heating zone 12, one consisting of three elongate substantially straight sections 70, extending at one end region of the first heating element 6, interconnected by loops 72, 74, the other consisting of three elongate substantially straight sections 76, extending at the other end region of the first heating element 6, and interconnected by loops 78, 80. The terminal regions 16, 20 traverse the second heating zone 12 in the same way as previously described with reference to FIG. 1.

The elongate substantially straight sections 70 of the conjoined terminal regions 20 are electrically connected in parallel by welding them together at regions 82, 84 at opposite ends thereof. A looped distal region 86 of the second heating element 10 is also electrically connected by the weld 84 to one of the end regions of the first heating element 6 to form the conjoined terminal regions 20. The elongate substantially straight sections 76 of terminal region 16 are also electrically connected in parallel by welding them together at regions 88, 90 at opposite ends thereof. The loops 72, 74, 78, 80 are effectively redundant and may be removed by cutting, if required.

The conjoined terminal region 20 is welded to electrical connector 32 of the terminal block 30, inside the heater and the terminal region 16 is welded to electrical connector 36 of the terminal block 30, inside the heater. A free end terminal region 18 of the second heating element 10 is welded to electrical connector 34 of the terminal block 30, inside the heater.

As a consequence of the arrangement of the first and second heating elements 6, 10 in the heater of FIG. 4 and the provision of the heating elements and the terminal regions 16, 18, 20 thereof as an integral component, it is necessary to cut the ribbon form heating element material at region 92 and to weld a resulting free end portion 94 to the free end terminal region 18 of the second heating element 10 at a weld region 96.

The radiant electric heater shown in FIGS. 1 and 4 can be modified in a number of respects. For example, the radiant electric heater need not be circular, but could be, for example, oval in configuration with the first heating element 6 occupying a substantially circular heating zone 8 and the second heating element 10 occupying a part-circular (or crescent shaped) heating zone 12 adjacent to the circular heating zone 8. Furthermore, a heater could be provided having more than two, for example three, heating zones, such as in concentric arrangement.

Instead of welding being used to electrically connect in parallel the sections of the terminal regions 16 and 20 traversing the second heating zone 12, other techniques, such as crimping or folding could be used.

1. A radiant electric heater comprising at least first and second adjacent heating zones, the first heating zone including a first heating element and the second heating zone including a second heating element, the heating elements being supported relative to a base of thermal and electrical insulation material, and terminal means provided at a periphery of the heater for connecting the first and second heating elements to a source of electrical energy, wherein the heating elements are formed from a single elongate electrically conductive member, the heating elements having a conjoined first terminal region connected to a first electrical connector at the terminal means, having free second terminal region connected to a second electrical connector at the terminal means, and having a free third terminal region connected to a third electrical connector at the terminal means, wherein at least one of the first, second and third terminal regions traverses the second heating zone for connection to the respective electrical connector.

2. A heater as claimed in claim 1, wherein the heating elements are in the form of a ribbon secured upright into the base of thermal and electrical insulation material.

3. A heater as claimed in claim 1, wherein the first heating zone is circular and the second heating zone is at least part-circular and at least partially surrounds the first heating zone.

4. A heater as claimed in claim 3, wherein the conjoined terminal regions of the heating elements comprise a looped distal region of the second heating element welded to a portion of the first heating element.

5. A heater as claimed in claim 1, wherein a peripheral wall is provided around the external periphery of the heater.

6. A heater as claimed in claim 1, wherein a dividing wall is provided between the adjacent heating zones.

7. A heater as claimed in claim 1, wherein a temperature-responsive device is provided for sensing the temperature in the region of at least the first heating zone.

8. A heater as claimed in claim 1, wherein the at least one of the first, second and third terminal regions traversing the second heating zone comprises a plurality of portions of the elongate electrically conductive member electrically connected in parallel.

9. A heater as claimed in claim 8, wherein the plurality of portions of the elongate electrically conductive member electrically connected in parallel comprise a plurality of elongate close meanders of the elongate electrically conductive member traversing the second heating zone and electrically interconnected thereacross at least at opposite ends thereof.

10. A heater as claimed in claim 9, wherein the plurality of elongate close meanders of the elongate electrically conductive member are electrically interconnected thereacross at least at opposite ends thereof by means selected from welding, folding and crimping.

11. A heater as claimed in claim 9, wherein the meanders comprise elongate substantially straight sections interconnected by at least one looped end.

12. A heater as claimed in claim 11, wherein the at least one looped end of the meanders has been severed subsequent to electrical interconnection of the meanders in parallel.

13. A heater as claimed in claim 1, wherein at least one of cuts and welds is provided at at least one portion of the elongate electrically conductive member.

14. A heater as claimed in claim 13, wherein the at least one of cuts and welds is provided to respectively disconnect and reconnect at least one portion of the elongate electrically conductive member.

15. A heater as claimed in claim 14, wherein the at least one of cuts and welds is provided to respectively disconnect and reconnect at least one portion of the elongate electrically conductive member at the terminal regions thereof.

16. A heater as claimed in claim 1, wherein the at least one of the terminal regions of the elongate electrically conductive member traverses the second heating zone such as to overlie the second heating element and be spaced therefrom.

17. A heater as claimed in claim 16, wherein the at least one of the terminal regions of the elongate electrically conductive member is provided in at least one recess formed in the base of thermal and electrical insulation material underlying the second heating element.

18. A heater as claimed in claim 1, wherein the at least one of the terminal regions of the elongate electrically conductive member traverses the second heating zone such as to underlie the second heating element and be spaced therefrom.

19. A heater as claimed in claim 18, wherein the at least one of the terminal regions of the elongate electrically conductive member is provided in at least one recess formed in the base of thermal and electrical insulation material underlying the second heating element.

20. A heater as claimed in claim 1, wherein the free first terminal region is provided in the second heating zone at an end of the second heating element remote from the conjoined terminal region, with the free second terminal region being provided at an end of the first heating element remote from the conjoined terminal region, the conjoined terminal region and the free first terminal region traversing the second heating zone.

21. A heater as claimed in claim 1, wherein the at least one of the terminal regions traversing the second heating zone is adapted to be substantially non-visibly radiating when the heater is energised.

22. A heater as claimed in claim 1, wherein the at least one of the terminal regions traversing the second heating zone is adapted to be of reduced visible radiance relative to the remainder of the heating elements when the heater is energised.

23. A heater as claimed in claim 1, wherein the third electrical connector is positioned intermediate the first and second electrical connectors.

24. A heater as claimed in claim 1, wherein the terminal regions of the heating elements are connected to the respective first, second and third electrical connectors by welding.

25. A heater as claimed in claim 1, wherein the terminal means comprises at least one terminal block supported at the periphery of the heater and accommodating the first, second and third electrical connectors.

26. A heater as claimed in claim 1, wherein the elongate electrically conductive member forming the first and second heating elements with their conjoined and free terminal regions is provided as a pre-formed component for supporting relative to the base of thermal and electrical insulation material.

27. A heater as claimed in claim 1, wherein a dish-like support is provided, receiving the base of thermal and electrical insulation material.

28. A heater as claimed in claim 27, wherein the dish-like support comprises metal.

29. A heater as claimed in claim 27, wherein the terminal means is supported at a peripheral rim of the dish-like support.
